(19) United States
(12) Patent Application Publication
(10) Pub. No.: US 2021/0104168 A1
(43) Pub. Date: Apr. 8, 2021

(54) SYSTEM AND METHOD FOR EDUCATION PLANNING, INDICATORS AND PATHWAY MILESTONES

(71) Applicant: Say Yes to Education, New York, NY (US)

(72) Inventors: Eugene Steven Chasin, Woodstock, CT (US); Martin Watson Bishop, Baltimore, MD (US); Melisandra Nadia Del Valle, Charlotte, NC (US)

(73) Assignee: Say Yes to Education, New York, NY (US)

(21) Appl. No.: 16/714,653

(22) Filed: Dec. 13, 2019

Related U.S. Application Data
(60) Provisional application No. 62/912,436, filed on Oct. 8, 2019.

(51) Int. Cl. G09B 5/02; G09B 5/14; G09B 7/07

(52) U.S. Cl. CPC G09B 5/02; G09B 7/07; G09B 5/14

(57) ABSTRACT

A cross-functional information system and method collect inputs from school systems, surveys, programs, service providers and other sources to provide a comprehensive set of indicators, red flags and milestones associated with students' heath, emotional-social well-being and academic performance to allow users to monitor students. When a student's status reflects a key indication, red flag or a milestone that is off track, the system creates a task list that allows a user to address each such student by enrolling the student in a program with a service provider to promptly address the issue. In this manner, the system and method provide a comprehensive approach to ensure students' well-being and ensure that they are on track toward a post-secondary school educational track.

### CROSS REFERENCE TO RELATED APPLICATION

The present application is related to and claims the benefit of priority of prior U.S. Provisional Patent Application No. 62/912,436, entitled SYSTEM AND METHOD FOR EDUCATION PLANNING, INDICATORS AND PATHWAY MILESTONES filed on Oct. 8, 2019.

### FIELD OF THE INVENTION

The present invention relates generally to information systems and methods, and more particularly, to educational information systems and methods for deployment by educators to facilitate student health and well-being and to facilitate students staying on track for post-secondary education by, for each enrolled student, monitoring progress indicators and/or red flags, developing growth plans, developing education pathways, and enrolling students in medical or educational programs when needed to ensure success.

### BACKGROUND OF THE INVENTION

Present educational database systems are inadequate to track a student's health and well-being, goals, progress and needs outside of the classroom. While individual systems exist to monitor students' academic performance and reported health issues, for example, there is no current comprehensive system to ensure student health, well-being and success in completing secondary school, well positioned to enroll successfully in post-secondary education. Prior efforts to ensure student success, including using computing systems, have included tracking student academics and performance. However, they have not included a comprehensive or automated approach to student well-being monitoring, red flag identification monitoring, notes on well-being and related access control, integration and enrollments to address issues or comprehensive reporting.

There is a need for an automated system that integrates data in such a manner that the system is able to comprehensively monitor each enrolled student and identify problems confronting students including red flags and indicators in a timely manner such that those problems can be conveniently and actionably addressed in a prompt manner to ensure student success.

### SUMMARY OF THE INVENTION

According to embodiments of the present invention, a cross functional information system and method operates by generating a continually updated profile on each student indicating his/her (a) current status in key indicators of academic, social-emotional, mental, and physical health; and (b) personal history in participating in programs or receiving support in these domains. In addition, it provides aggregate data on students' status and experiences for selected schools and the entire school district. The key “input data” are stored and aggregated in a database, and include information from family, school staff, school district records, and the students themselves. The input data identifies each individual's strengths and needs. From kindergarten on, each student's progress may be tracked and needs in particular areas (“off-track” indicators) addressed preemptively. Outputs from the system include individual student growth plans, district and school aggregate reports, and reports on interventions used to support students. Individual growth plans may be monitored through a user interface, indicators, red flags pathway milestones, and/or reporting to ensure that the student is minimally “on track” and optimally “on track to thrive” with regard to potential to graduate high school and succeed in post-secondary education.

According to one embodiment of the invention, a management system is coupled to a database that includes information for each student including indicators of social/emotional/mental/physical health regarding a student from at least one input source including parents, students and teachers. The management system includes a user interface that may be used by specialists or student support teams to identify adaptive interventions during the school day, expanded learning time (ELT), and other out-of-school time settings. The outcomes and intervention data are then shared with regular teachers and ELT instructors/tutors to guide adaptations to learner needs. Student participation may be recorded as part of the PPS data base, so that intervention dosage, enrollment, and relationship to achievement outcomes can be examined.

According to another embodiment of the present invention, an educational database associated with an educational management system includes a collection of current student data in multiple domains and access to this information is tightly controlled to ensure parental consent to use of the information and controlled use of the information. For example, the information may be controlled so that only those who work directly with particular students (a) at the school level (teachers, principals, FFSs, and Student Support Team (SST members) and (b) across several schools (service agencies), or others as needed or desired, have access to student information to facilitate addressing matters with each student and the student's family.

The educational database and management system may also be used to aggregate data from student populations or groups of students or, for example, participation in particular programs. Aggregated data may then be used, for example, for comparisons of on-track/off-track status on a selected indicator between all fifth-grade students based on various demographic breakdowns or by gender. Many types of analyses may be made using aggregate data that can then in turn be used by specialists to direct help to particular student groups. Access to aggregate data may be similarly controlled to restrict aggregate data to students within a particular school district.

According to one embodiment of the invention, a cross-functional information system facilitates constructive student intervention and includes a memory, a database and processor. The memory stores computer program instructions that facilitate database access and providing data for a user interface that highlights indicators and red flags for students to a user. The database stores for each student at least indicators, red flags and enrollments.

The processor is coupled to the memory and the database, and executes the computer program instructions in order to: (a) present information to a user via a user interface in the form of a task list for students that have at least an indicator or a red flag that signify that a student needs help; (b) present information to the user on available programs appropriate to the type of red flag or indicator being acted upon; (c) present the user information on service providers that are available to provide the available program; and (d) enroll the student in the available program with the available service provider. The processor may further (e) enroll a student in the available program; (f) track program attendance and provide attendance data to the case manager; and (g) electronically notify the case managers, service providers and optionally the student and the student's parents of results based on the services or completion of the services; and (h) create notes explicitly tied to system entities (student, referral, program, red flag or indicator) presented in a centralized view but associated in a way that allows granular access control and also capturing notes actions associated with a particular entity.

The processor may further execute the program instructions to develop student growth plans for each student based on the school district records for each student, the online survey data, statewide data and the service provider data and present an interactive growth plan for each student to the case managers. The processor may further use the data records to determine pathway milestones for each student based on the school district records for each student, the online survey data, statewide data, and the service provider data and present the pathway milestones for each student to the case manager. The online survey data may include data associated with physical health, mental health, medical care, dental care, home environment, postsecondary aspirations, and special care and such data may be used by the processor to create aggregate reports on student well-being, including reports aggregated according to at least one data measure including red flags, indicators, pathway milestones, survey responses and filtered according to at least one of the following data characteristic demographic, geography, and school.

According to another embodiment of the present invention, a method is provided that facilitates constructive student intervention including the steps of configuring a management system to have access to a student record database; providing the student record database with records associated with student school district records, on-line survey data, service provider data; configuring security related access parameters for administrators and third parties to portions of the database; calculating for each student a growth plan, red flags and enrollments based on the school district records for each student, the online survey data, statewide data and the service provider data; and providing a user interface to case managers and third party service providers. The method enables the system to: (a) present an interactive task list for students that have at least one of an indicator or a red flag that signify that a student needs help; (b) present an interactive list of available programs associated with each indicator or red flag associated with each student, filtered to exclude programs that the student is not eligible to participate in; (c) present an interactive list of service providers that are available to provide the available program to each student in need; and (d) enroll a student in the available program with the available service provider. The method may further include providing an interactive user interface to third party service providers to enable communication and updating of the database to: (e) enroll a student in the available program; (f) track program attendance and provide attendance data to the case manager; and (g) electronically notify the case managers, service providers and optionally the student and the student's parents of results based on the services. Additional functionality is described in more detail below.

### BRIEF DESCRIPTION OF THE FIGURES

The above described features and advantages of embodiments of the present invention, will be more fully appreciated with reference to the appended figures, described below.

FIG. 1 depicts an educational information system according to one embodiments of the invention.

FIG. 2 depicts a functional block diagram of data collection and analysis performed in an educational information system according to one embodiment of the invention.

FIG. 3 depicts a functional block diagram of data collection related to students and analysis performed in an educational information system according to one embodiment of the invention.

FIG. 4 depicts a functional block diagram of data collection and reporting performed in an educational information system according to one embodiment of the invention.

FIG. 5 depicts a functional representation of data input, functionality, user interfaces, and outputs in an educational information system according to one embodiment of the invention.

FIGS. 6-13 depicts exemplary views of a user interface presenting data on a student in an educational information system according to embodiments of the present invention, including indicators, pathway milestones, red flags, profile, enrollment and other information.

FIGS. 14-16 depict exemplary views of a user interface presenting data for an administrator to use in managing tasks, or actions that can be taken, associated with helping students who are off track or need to enroll in programs, for example, according to embodiments of the present invention.

FIG. 17 depicts an illustrative view of key indicators and related database entries that are used to monitor students according to an embodiment of the present invention.

FIG. 18 depicts an illustrative view of milestones and related database entries that are used to monitor students according to an embodiment of the present invention.

FIG. 19 depicts an illustrative view of data associated with a service provider that is configured to accept enrollment of students according to an embodiment of the present invention.

FIG. 20 depicts an illustrative view of a user interface for enrolling a new user.

FIG. 21 depicts an illustrative view of data associated with a service provider that is configured to accept enrollment of students according to an embodiment of the present invention.

FIG. 22 depicts an illustrative view of programs offered to students and data associated with each program according to an embodiment of the present invention.

FIG. 23 depicts an illustrative view of a health indicator and sub indicators and related data according to an embodiment of the invention.

FIG. 24 depicts an illustrative view of a user interface for a system administrator to provision users according to an embodiment of the present invention.

FIG. 25 depicts an illustrative view of a method according to an embodiment of the present invention.

FIG. 26 depicts an illustrative view of an apparatus that interacts with parents, case managers, administrators and service providers to ensure student well-being and achievement according to an embodiment of the invention.

### DETAILED DESCRIPTION

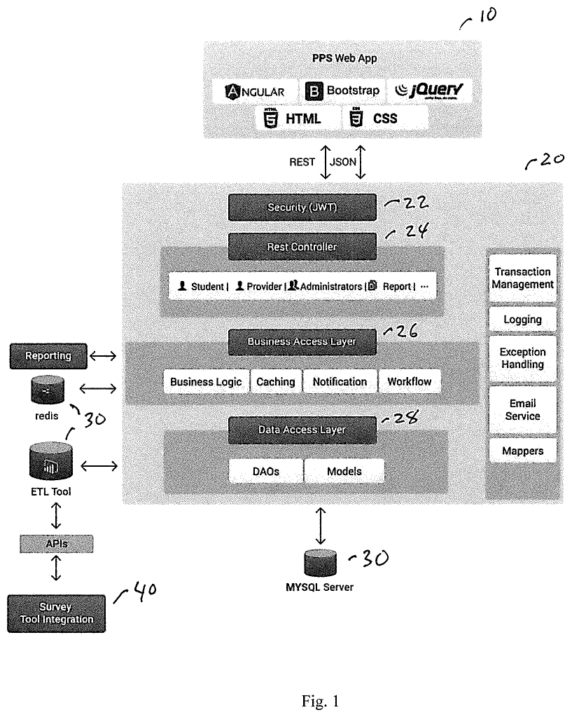

According to embodiments of the present invention, a cross-functional information system and method operates by generating a continually updated profile on each student indicating his/her (a) current status in key indicators of academics, social-emotional, mental, and physical health; and (b) personal history in participating in programs or receiving support in these domains. In addition, it provides aggregate data on students' status and experiences for selected schools and an entire school district or districts. Recognizing the importance of health, social and emotional, financial and academic risks to the prospects of a student completing secondary school with a solid foundation to pursue post-secondary education, removing or mitigating these risks for students is an important step. Removing or mitigating these risks is a desired end goal of the systems and methods described herein. In the middle are the essential and challenging tasks of identifying where and how each risk or barrier exists for individual students, and then selecting and providing the interventions likely to work best. With those objectives in mind, various embodiments of the educational system and method and their operation are described below and with reference to the appended figures. FIG. 1 depicts an illustrative cross-functional management system within an overall system framework according to one embodiment of the invention. Referring to FIG. 1, the system includes a web application 10, a management system 20 with various layers, databases 30 and a survey tool 40. The management system 20 integrates a security layer 22, a reset controller 24, a business access layer 26 and a data access layer 28. The databases 30, which may be central or distributed, individually or collectively include for each student, all of the information about each student relevant to the system, as described in more detail below. This information includes indicators, such as:

### Indicators:

Medical health

Mental health

Dental health

Vision

Nutrition

Social health

Healthy adult relationships

Culture

Peer relationships

Support at home

While the above list is illustrative, there are many other indicators of risks to student performance and any or all of those may be included as indicators according to the systems and methods described herein. According to one embodiment of the invention, some indicators may be obtained from surveys taken from students, teachers, parents, and/or other professionals. The indicators may include associated data to score each student. For example the score could be from 1 to 3 corresponding to thriving, on track or off track. Those students that are off track may be flagged for processing by the system to create an intervention that will get the student back on track.

Another portion of the databases 30, which may be central or distributed databases, may store programs that are provided at the school, outside of the school, during school hours or outside of school hours. The programs are classes or sessions that are provided by service providers, faculty or other professionals to address deficiencies in the indicators. Each program may be correlated in the database with one or more indicators. Service providers may also be stored in the database to provide programs to students. For example, service providers specializing in mental health or improving social skills may be set up in the database along with information to identify the name, location, hours of operation, classes or sessions available and other similar information.

The information for the service providers may be stored in the database and correlated with programs. When one or more students go off track for one or more indicators, the system may use the program and service provider information stored in the database to create tasks for users of the educational information system to use to cause each user assigned to an off track student to enroll that student in a program. A service provider associated with the program and the indicator will then address the off track indicator after the student is enrolled in the program and attends the program. The database also tracks enrollments for students in the programs, performance of the service providers as well as students' academic goals, academic achievements, and progress along milestones. The database stores information on red flags associated with each student. Red flags are determined based on certain indicators or events and when red flags occur are put on a user's task list to intervene and get the student help in the area of the red flag.

The web application(s) 10, which may include one or more application programs, interact with the management system and the database in order to present users and administrators of the system a user interface through which to enter data and interact with the system. The figures appended to this application present a number of views of illustrative user interfaces that may be presented according to embodiments of the present invention to make information about students in the system available to users, to create task lists for users to enroll students in programs and to monitor students' progress as well as to generate reports on individual students or student groups or populations in aggregate.

There may be separate reporting programs 50 that interact with the management system or the reporting functionality may be incorporated within the management system. In addition, a survey tool 40 may be used to present surveys to students, teachers, parents and or others to provide information on key indicators into the system. The surveys can be done with any frequency or at any time in order to keep the information about each student current. The survey data may be fed through an extract, transform, load (“ETL”) tool 55 in order to reformat the data so that the survey results can be properly and consistently stored in the database. The management system may be implemented on a general purpose computer with a memory, processor, databases, and input/output devices pursuant to which the memory stores computer program instructions that are executed by the processor to run application programs or operating systems and exchange and process data as described herein with users and databases.

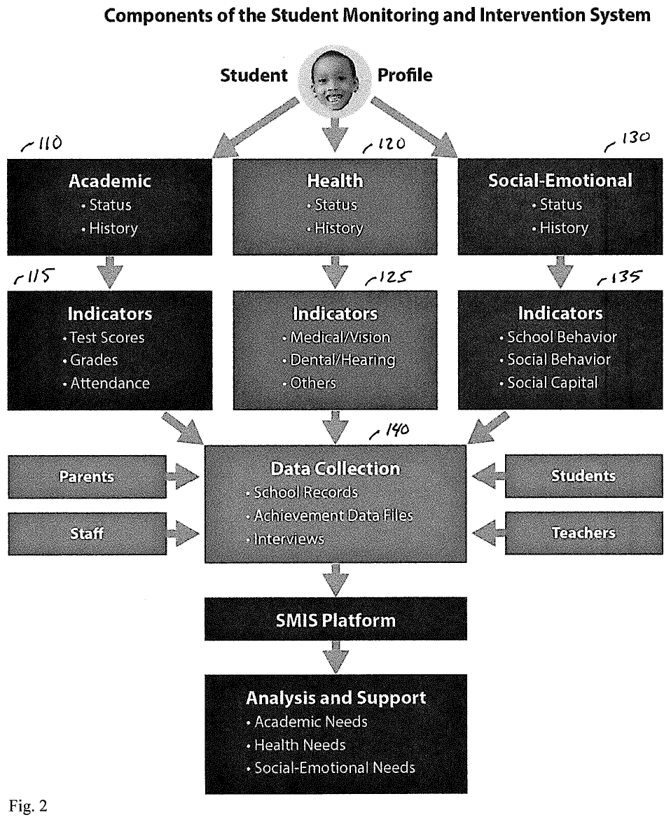

FIG. 2 depicts a functional block diagram of data collection and analysis performed in an educational information system according to one embodiment of the invention. Referring to FIG. 2, information, including but not limited to, academic information 110, health information 120 and social-emotional information 130 may be stored, both current status and history, in a database or data collection. Additionally, indicators 115, 125 and 135 are respectively associated with academics (test scores, grades, attendance), health (medical/vision, dental, hearing, others), and social-emotional (behavior, social behavior, social capital) and may be stored in the data collection or database 140. Parents, staff, students and teachers may also store information in the data collection. Staff, teachers or students may provide information to the system via surveys. The data collection may also receive information as a result of student interviews, school records and achievement data files associated with enrollments in programs or from other sources or professionals. The management system accesses the data collection 140 in the database and is able to perform analysis on the academic, health and social-emotional needs of each student and create red flags, thriving, on track or off track indicators, and on that basis create task lists for staff or administrators to enroll students in programs to address the off track indicators or red flags as they happen. The service providers may also use the system to update the status for each student that attended a program and score the student on the same criteria of health, academic, and social-emotional welfare. In this manner, actionable information about a student's key indicators are made available and put into task lists for administrators to use to make timely interventions to keep students on track. Indicators, such as a health indicator and sub indicators and related data identified to the system, may be configured to be used within a particular school district or school, or for a group of students.

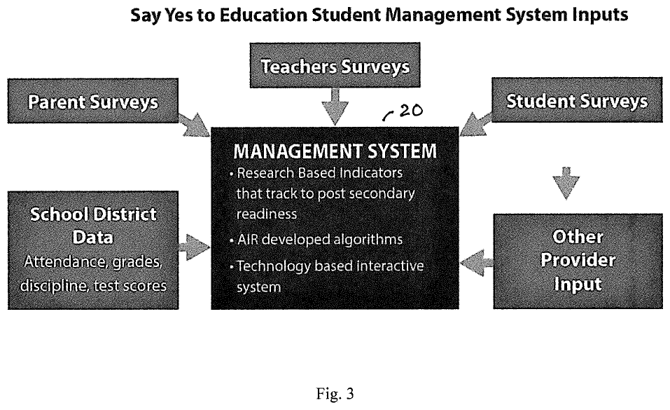

FIG. 3 depicts a functional block diagram of a data collection related to students and analysis performed in an educational information system according to one embodiment of the invention. This figure highlights that surveys from parents, teachers and students are fed into the system 20. This may be done through web interfaces where the data from the survey is post-processed through an ETL tool and stored in the database for each student. Additional information made available to the database and management system may come from a school district's data on attendance, grades, discipline, and test scores, for example. In addition, other service providers may provide input about students through survey or other formats. The information may come out of the service provider interacting with a student in an enrollment, for example, and may be provided in the form of notes.

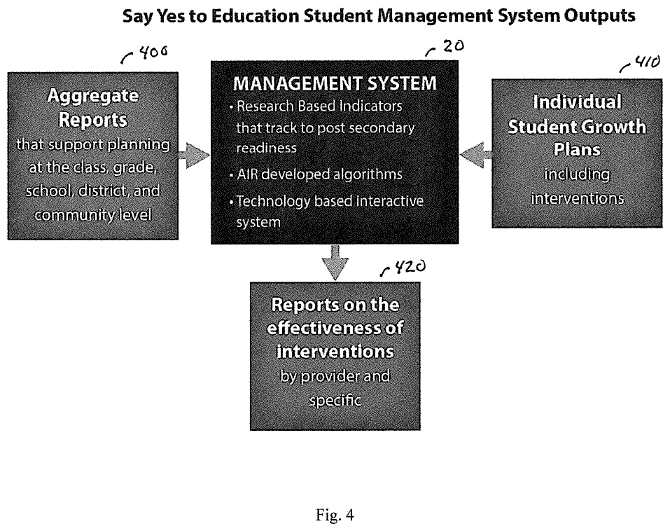

FIG. 4 depicts a functional block diagram of data collection and reporting performed in an educational information system according to one embodiment of the invention. The reporting programs may be executed by the processor on the management system or in a distributed architecture in another system with the data or reports made available to the management system. Referring to FIG. 4, reports 400 run on an aggregate level for students in a particular grade, class, school district or community may be run by the system by processing student data and made available to users, particularly case managers, of the system. The aggregate report may identify patterns or trends for students in a particular class, grade, zip code, or other grouping that may then be used to accomplish objectives for a class, grade, community, or school district. For example, when such a group shows a percentage of students with the same kind of off-track indicator or red flag, remedial action may be taken through group enrollments or programs during school time to address a significant or wide-spread issue. Individual student growth plans 410 may also be developed and stored in the management system and database based on each student's desires and needs and overall objectives and data stored in the system databases. The management system 20 may also generate various reports 420, including a report on the effectiveness of interventions. For example, after a student enrolls in one or more programs to address an off-track indicator or red flag, that student may eliminate the red flag or raise the off-track indicator to an on track or thriving. The reports allow the effectiveness of the programs or interventions to be tracked for individual students, programs, service providers or in aggregate.

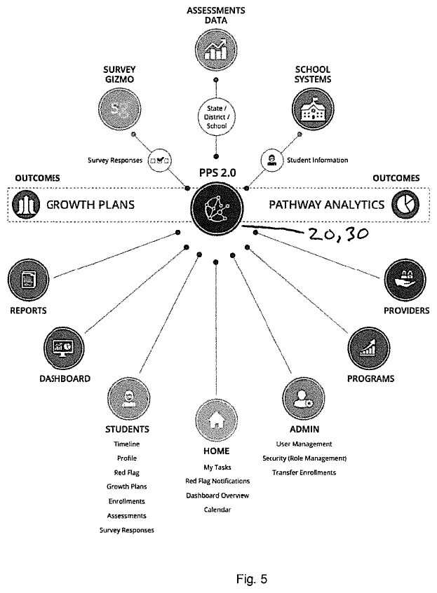

FIG. 5 depicts a functional representation of data input, functionality, user interfaces, and outputs in an educational information system according to one embodiment of the invention. It illustrates another view of the management system 20 and databases 30 at the center of a group of functionality that facilitates collecting and analyzing information on students, and creating growth plans and pathway milestones and analytics. The functionalities shown allow a comprehensive set of user interfaces to be provided to various groups to interact with the system to create and update on enrollments, programs, student progress and reports. Dashboard functionality allows users to quickly see task lists and other information that the user is required to process to keep a group of students for which the user is responsible on track. It also allows individual students' profiles and status to be viewed together with thriving, on track and off track indicators, and red flags to get a comprehensive take on a student's well-being and on what is being done in real time to correct any off-track indicators or red flags.

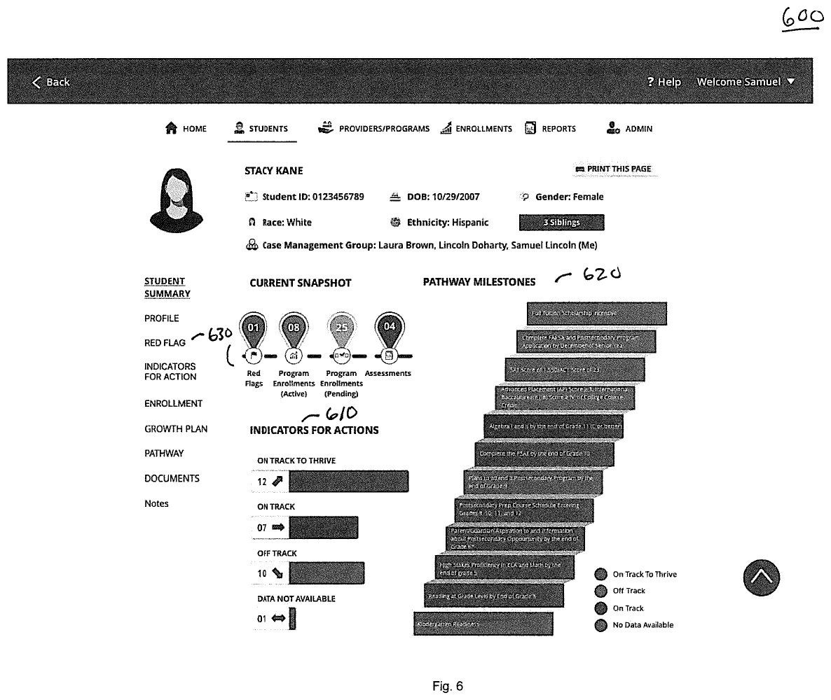

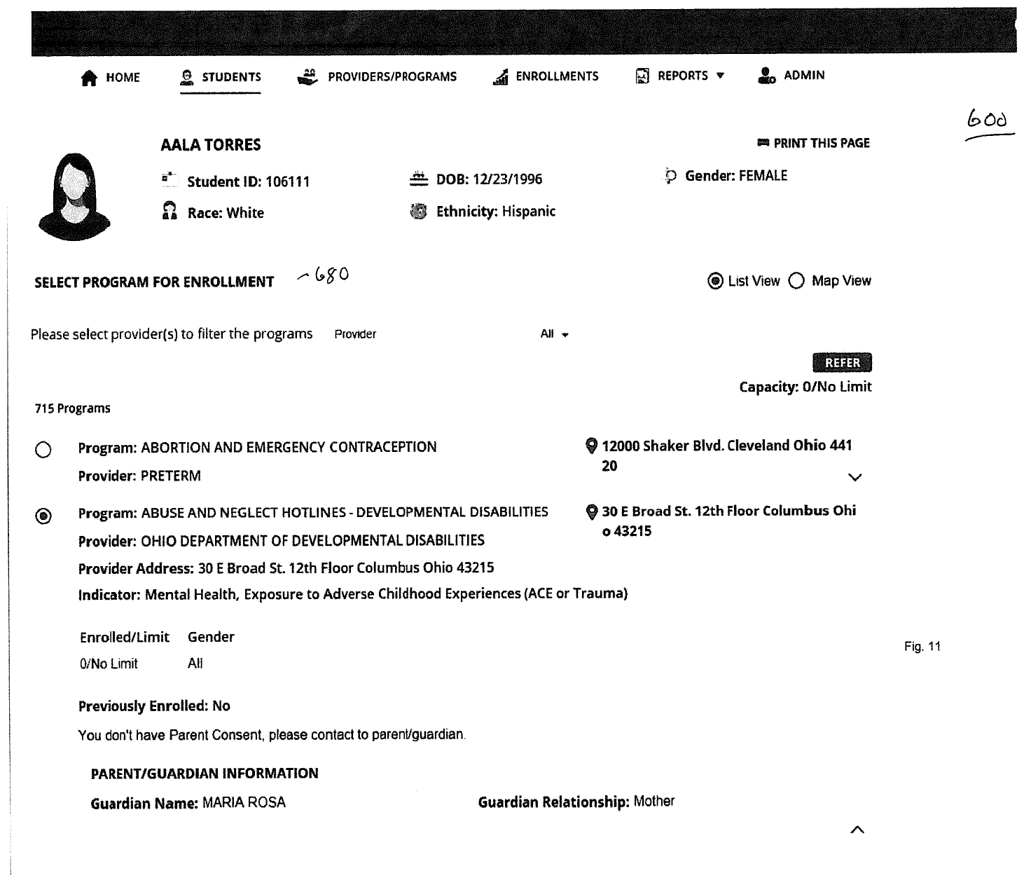

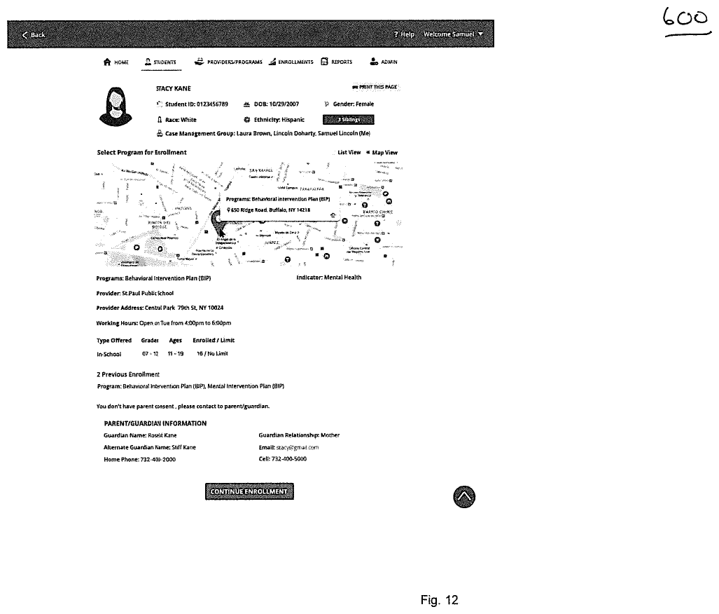

FIGS. 6-13 depict exemplary views of a user interface 600 presenting data on a student in an educational information system according to embodiments of the present invention, including indicators 610, pathway milestones 620, red flags 630, profile, enrollment and other information. These views may be displayed by the web application for example.

Referring to FIG. 6, an interactive web interface presents student information, including student id, race, date of birth, gender, and ethnicity. The student information collected in to profiles, indicators, pathway milestones, red flags and other categories of information shown and determined based on software reporting using information on students obtained from the databases 30 and surveys. FIG. 6 also presents selectable hypertext links including profile, red flags 630, indicators for action, enrollment, growth plan, pathway, documents and notes. It further highlights a current snapshot of a student, including red flag information, active program enrollments, pending program enrollments and assessments, in addition to indicators 610 for action for the particular student selected. Pathway milestones 620 are also illustratively shown.

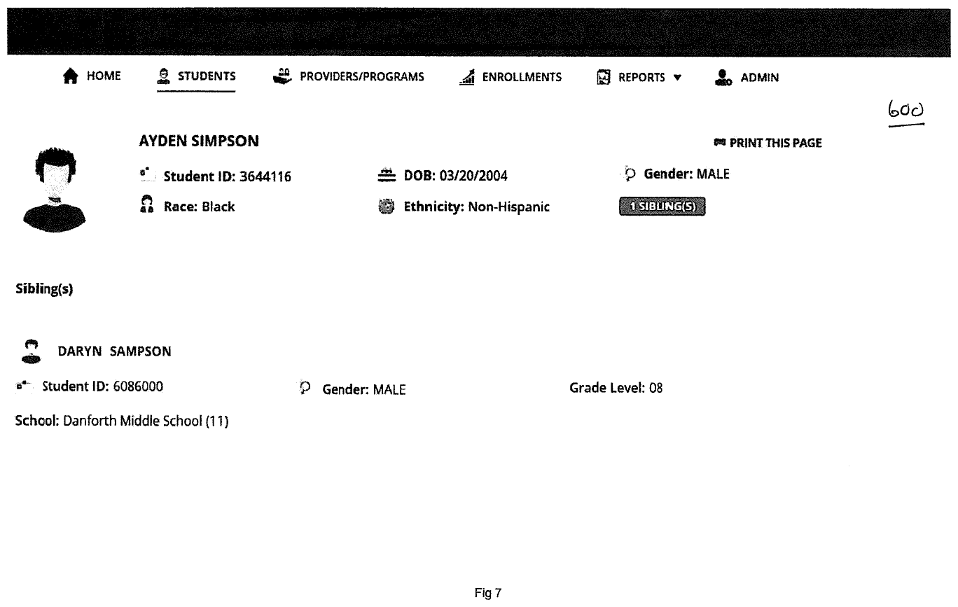

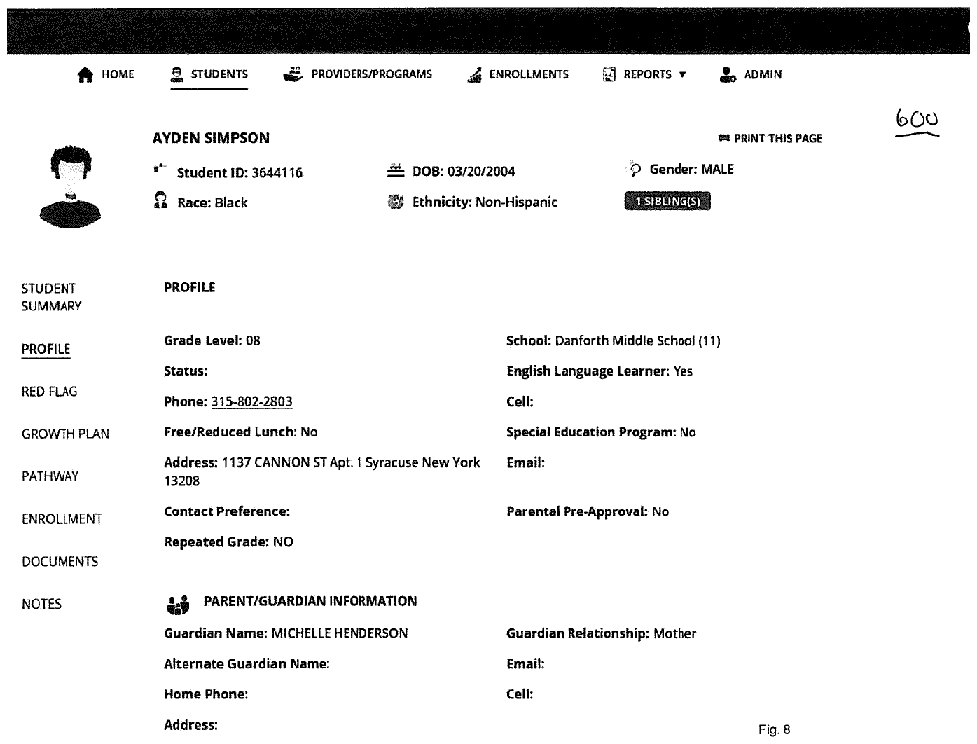

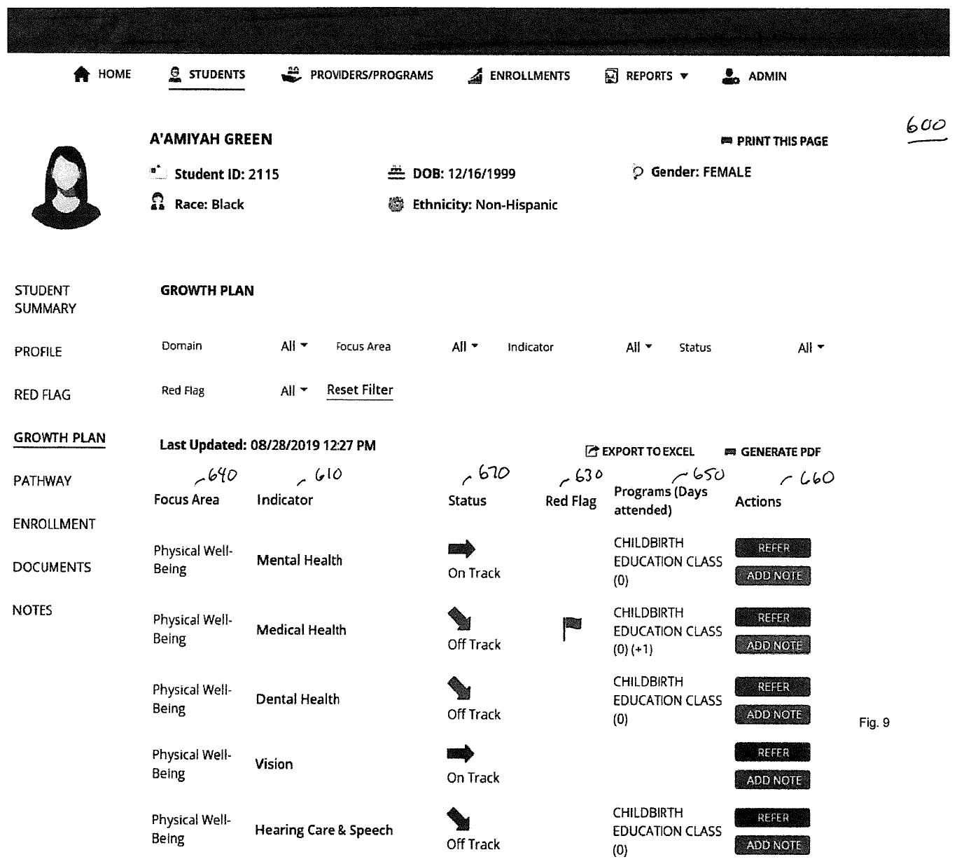

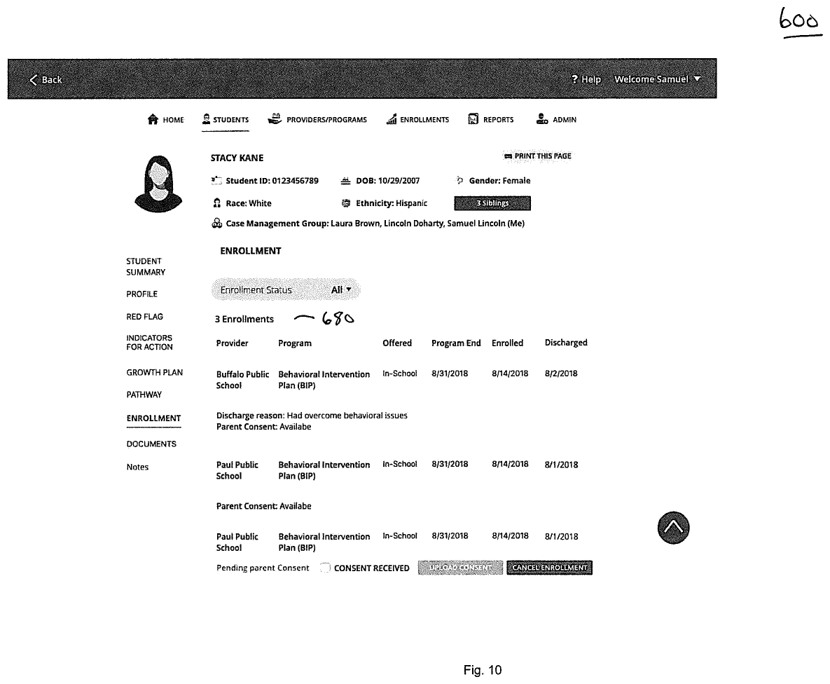

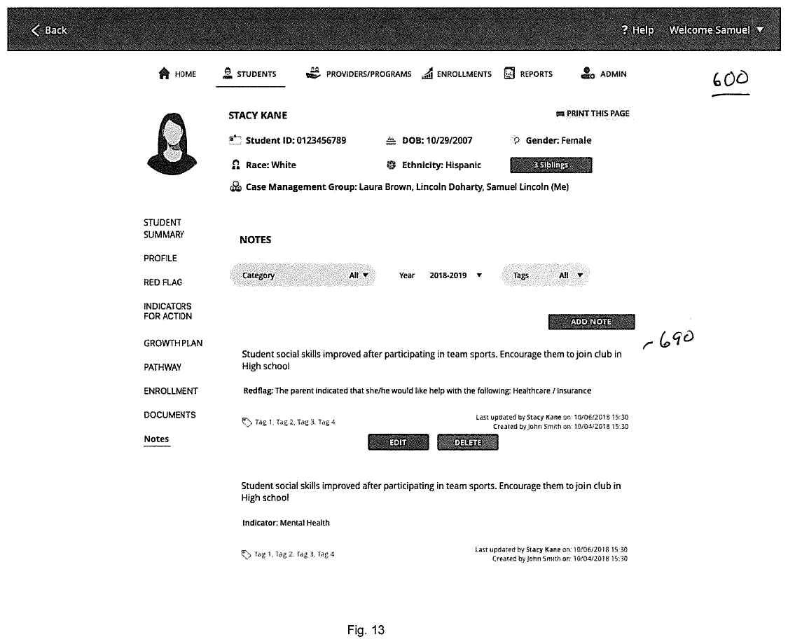

Referring to FIG. 7, the illustrative user interface 600 displays additional student information, including the student's school and grade level. Referring to FIG. 8, an illustrative student profile is presented in the user interface 600 that includes additional student information, an including address, special education program, language, phone number, free/reduced lunch indicator, and parent/guardian information. FIG. 9 presents an illustrative growth plan via the user interface 600, including indicators 610, focus areas 640 with corresponding status 670, red flags 630, and programs 650 and actions 660. FIGS. 10-12 depict illustrative enrollment screens via the user interface 600 and provide enrollment information 680. FIG. 13 depicts notes 690 associated with a student, that are further associated with a red flag 630 in one case and an indicator 610 in another case.

The web applications 10 that produces the user interfaces 600 described above, and all other functional blocks shown in this application, may be implemented by software programs running on a general purpose or specific purpose computer. The computer includes a processor and memory. The software programs include program instructions that are stored in the memory and executed by the processor to perform the functionality described herein. The users, students, case managers, administrators, service providers and others generally may use their own computers (or phones, laptops, tablets, etc.) that run an application program, such as a web application, to interface with the management system via the Internet and/or other networks. The management system 20 may exchange information with the web interface via secure protocols such IP protocols, JSON, REST, and any other protocol for exchanging information. The management system 20 and other computers used for access generally include displays, keyboards, networks connectivity, and input devices that facilitate user interaction with the information displayed by the application programs and user interfaces. Survey software may be stored on the management system and made available to the management system through user interaction with a web page. Alternatively, the surveys may be hosted elsewhere with the data transmitted to the management system via an ETL tool, for example.

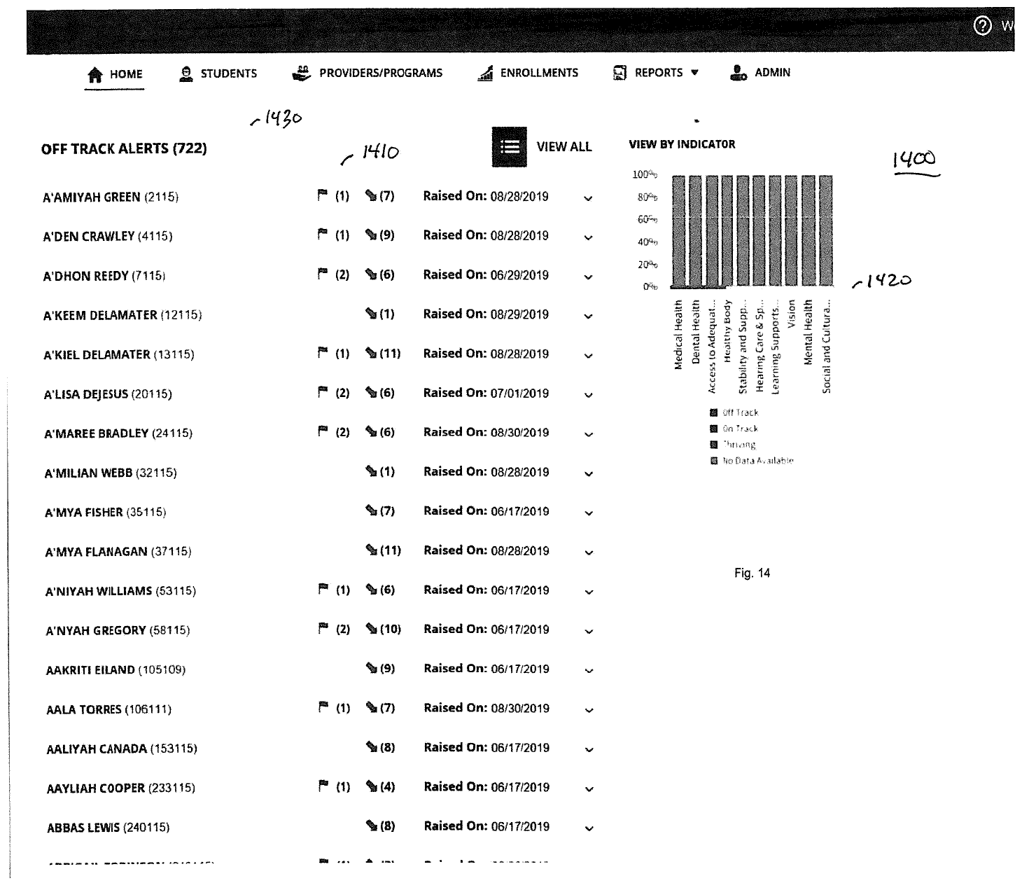

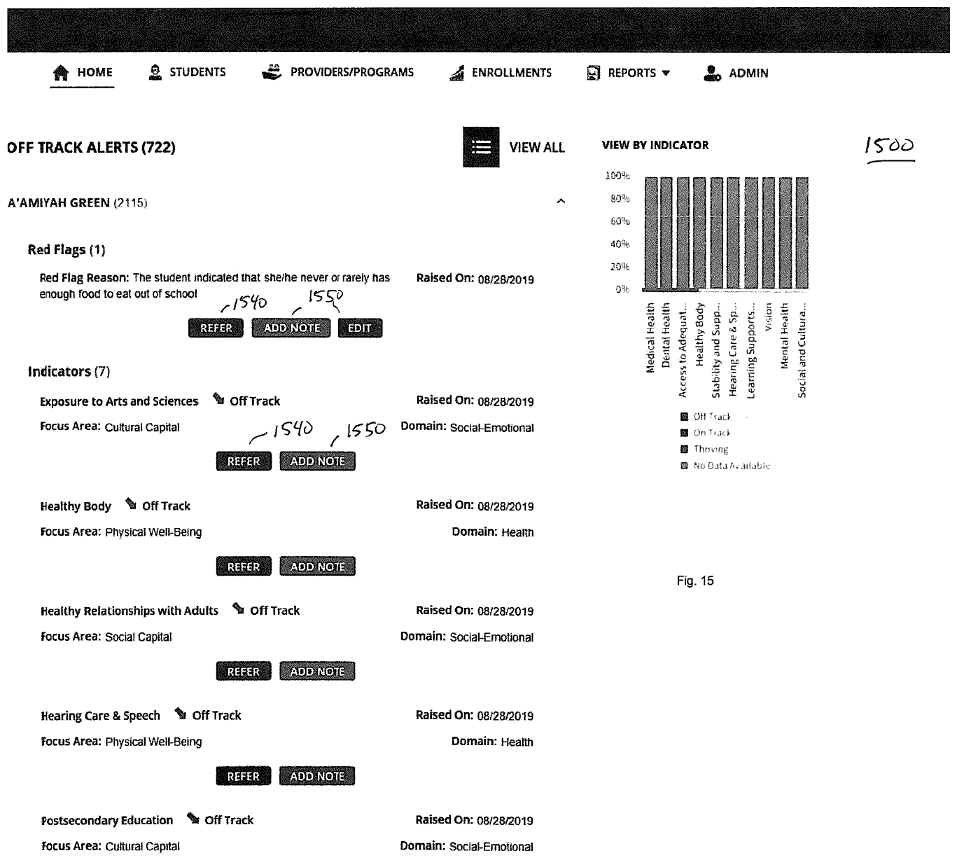

FIGS. 14-16 depict exemplary views of a user interface 1400 presenting data for an administrator to use in managing tasks associated with helping students according to embodiments of the present invention. For example, FIG. 14 shows a series of students with red flags 1410 and/or off-track indicators 1420 for a particular user of the system. The user interface is shown to allow selection of a student from the list 1430 and to enroll a student who is off track or who has a red flag in a program correlated with the indicator or red flag. This is an illustrative view and the data shown can be changed and displayed to make use of any desired objective to help the user efficiently process enrollments or interventions to help students who are off track. FIG. 15, for example, illustratively shows for one student a user interface screen 1500 presenting red flags 1510 and indicators 1520. The user interface 1500, for example, includes interactive links 1540 and 1550 that respectively allow a case manager to refer the student with or without notes to a program or for enrollment and separately to add or edit notes associated with indicators and/or red flags. In other words, the notes may be associated or coupled with other data in the system, including referral requests, indicators or red flags, which allows increased granularity associated with helping a student. Certain system users, such as a case manager, may have access to notes for a particular student. Others may not, depending on their configuration by the system administrator. Also, access control permissions may be configured such that a case manager may be able to see notes associated with some referral requests but not others. The system also may enable the inclusion of an act of taking a note into a larger category of “user actions taken for a thing,” for example. This provides greater user activity transparency and more information for use by certain case managers.

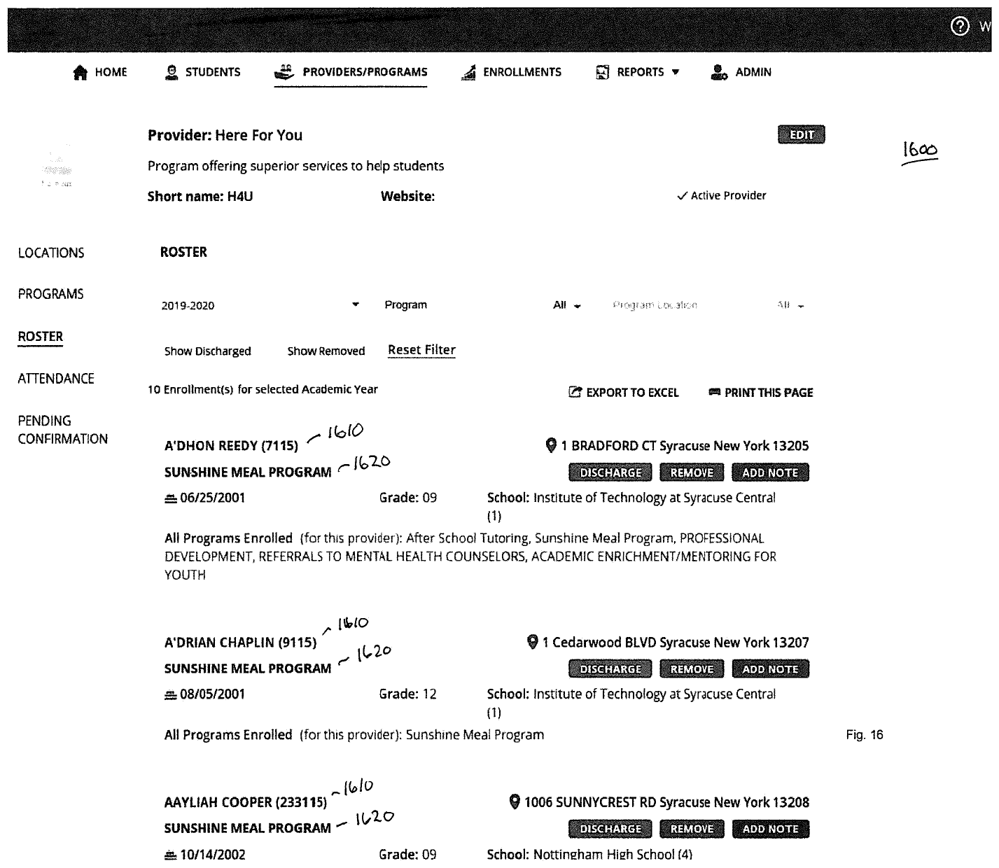

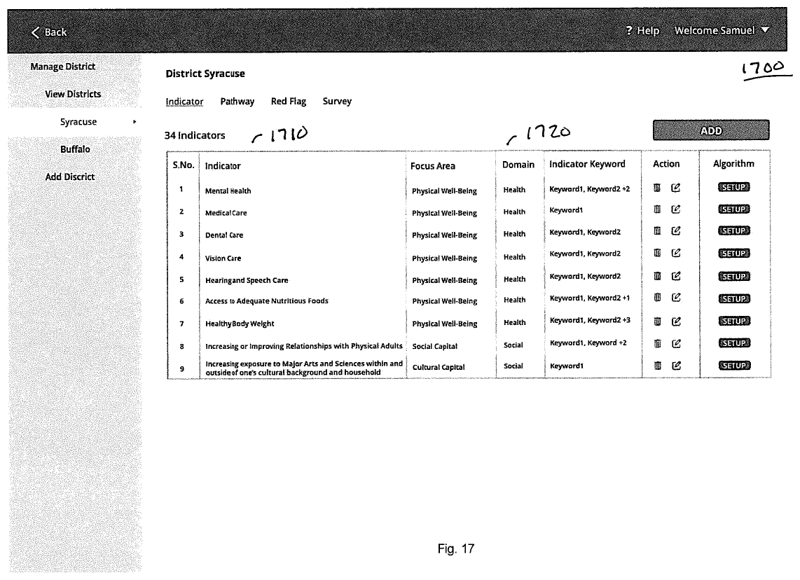

FIG. 16 shows an illustrative user interface 1600 view of a roster of service providers 1610 available for particular programs 1620 and students or schools. FIG. 17 depicts an illustrative view 1700 of key indicators 1710 and related database entries 1720 that are used to monitor students according to an embodiment of the present invention. There may be a large number or small number of indicators depending on how the system is configured. In general, the indicators relate to emotional, academic, health, and financial and other criteria that create risks for students and need to be monitored, as explained in further detail above. The indicators may be based on a single survey question, multiple survey questions, on pieces of information obtained from an academic or other database, notes from a teacher, parent or the student or combinations of the foregoing. The indicators generally are scored in an algorithm and presented with the score or a representation of the score such as thriving, on track or off-track so that the user charged with administering the student on the system can quickly get a view of how each student is currently situated at any given time across indicators and red flag criteria. The red flags similarly can be based on any of the foregoing information. The algorithm may reflect a score from a survey, for example, of 1 to 3 depending on the response of a student, parent and/or teacher. Alternatively, the score may be determined from other data in the database such as a medical condition, or an academic result. The scores for each indicator are correlated with each student and available to use in determining goals, milestones and/or enrollments for each student.

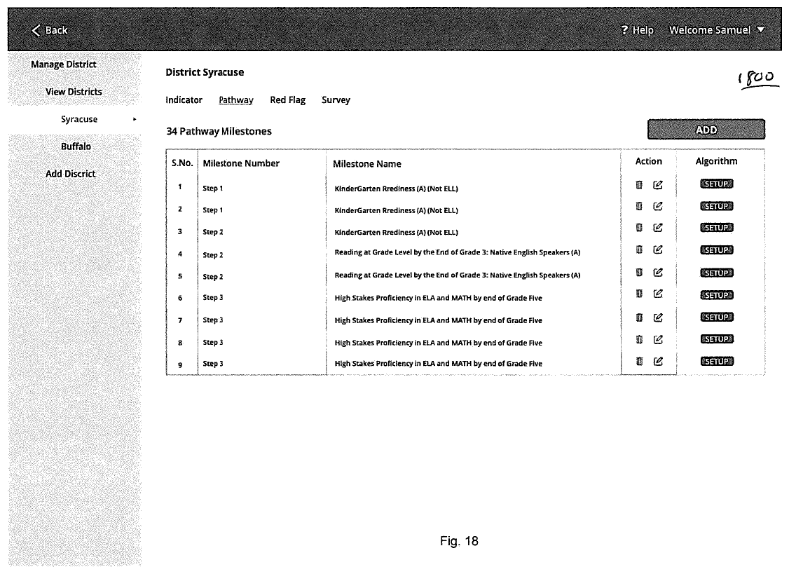

FIG. 18 depicts an illustrative view of milestones 1800 and related database entries that are used to monitor students according to an embodiment of the present invention. The milestones and other information in the database and system may be tailored for a school district a community, region or other line of demarcation. The milestones generally may span from kindergarten through grade 12. According to one embodiment of the invention, the milestones are chosen to provide key milestones that when achieved provide an indication that student is on track for post-secondary school education and that when not achieved show the opposite. In this manner the milestones may be presented in a dashboard format, and users may see graphically when a student is off-track toward a post-secondary progression, even at an early age or grade level. The algorithm associated with each milestone may be a score or data reflecting on track or off track for the milestone, and the score may be determined from information on the student in the databases, including academic achievement, interests, goals including post-secondary aspirations and other information reflecting on a student's scholastic trajectory,

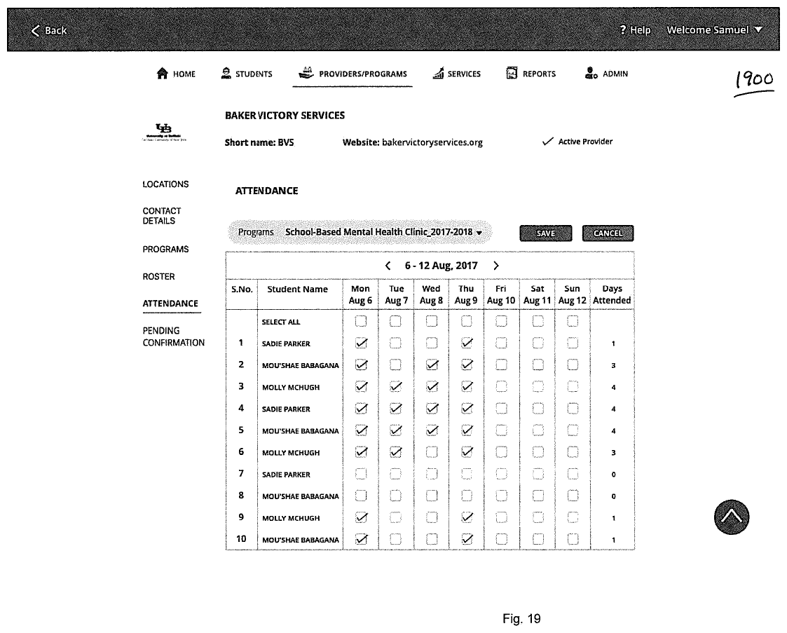

FIG. 19 depicts an illustrative view 1900 of data associated with a service provider that is configured to accept enrollment of students according to an embodiment of the present invention. This particular user interface shows a service provider, a calendar week, and all of the enrolled students and their attendance each day. This information may be stored in the database and is used to track student progression through enrollments, lack of attendance and performance of service providers. The service providers may provide and update this information through a web interface as described above.

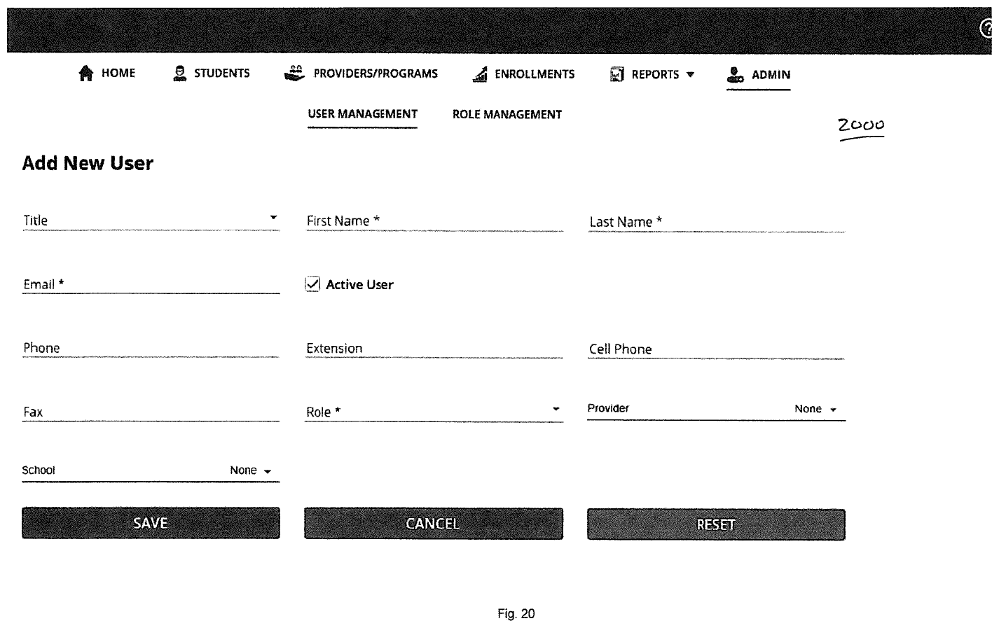

FIG. 20 depicts an illustrative view of a user interface 2000 for enrolling a new user of the system. The user provides the user's name, contact information (including phone numbers), school and other information to register with the system. The user will be given a username and password to access the system and may have to agree to privacy and other terms of use to safeguard personal information of the students. All of this information may be stored in the database and used to later authenticate the user when the user logs on.

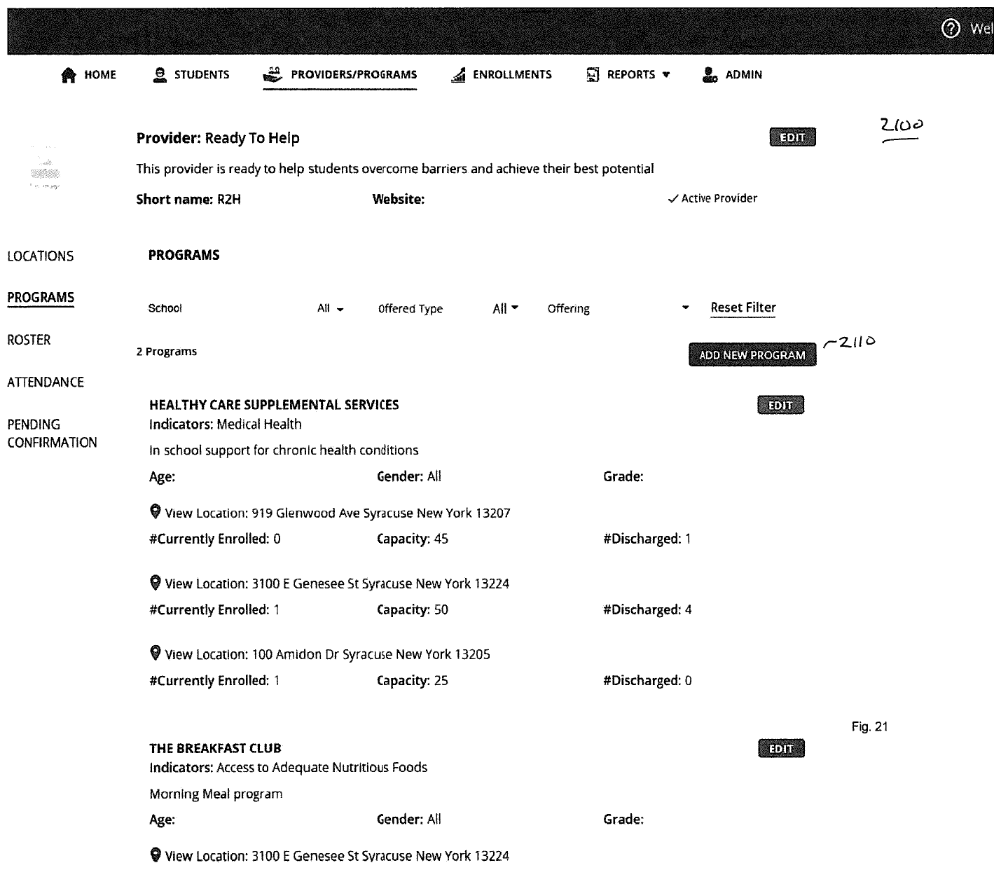

FIG. 21 depicts an illustrative view 2100 of data and programs associated with service providers. Referring to FIG. 21, new programs may be added to service providers with the interactive link 2110. Service providers and programs when added may be configured to accept enrollment of students according to a parameters and information as illustratively show, such as, for example, the capacity of the service provider, the address, the grades, ages and other limitations of the programs each service provider provides. The type may be in school or out of school programming. The service provider may also be correlated with indicators or red flags.

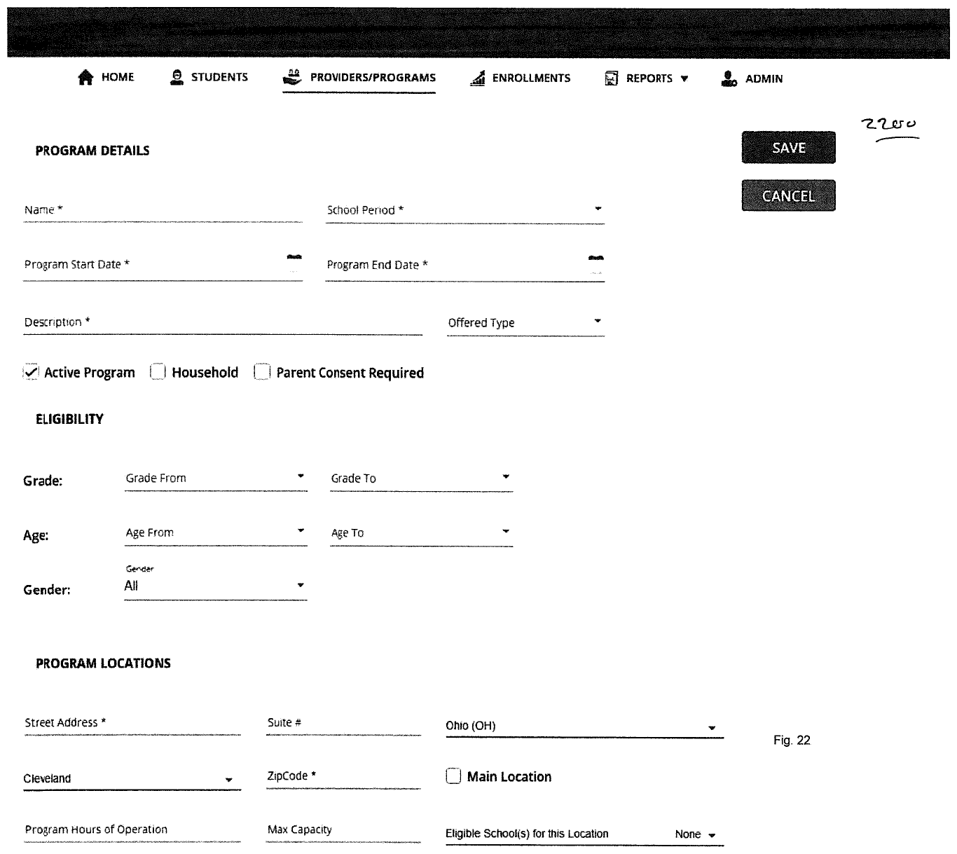

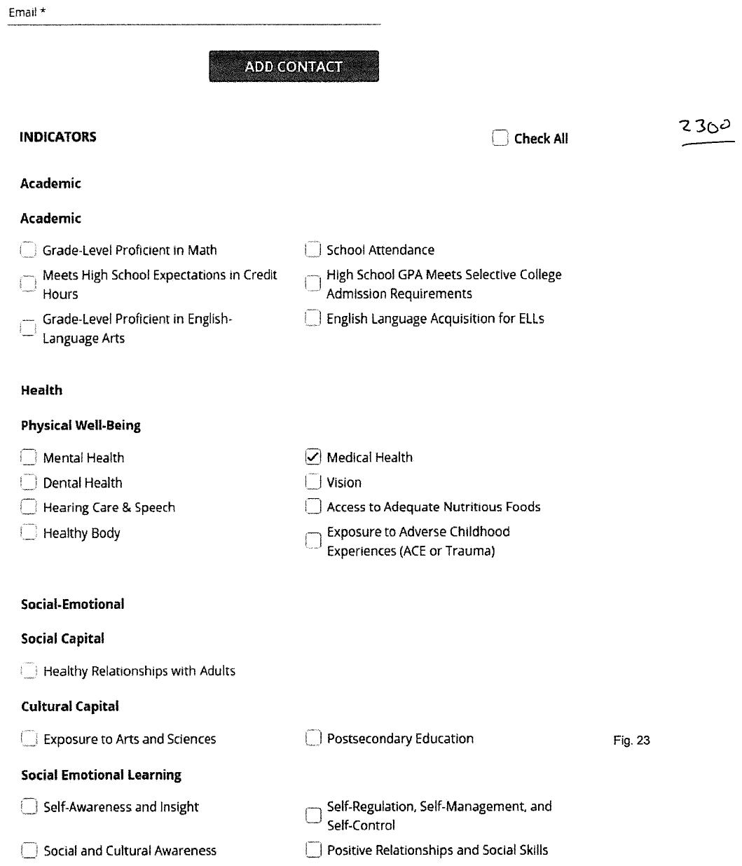

FIG. 22 depicts an illustrative view 2200 of programs offered to students and data associated with each program according to an embodiment of the present invention. A web user interface such as the one shown may be used to display available programs or allow users to enter new programs into the system in which students can enroll. The information, including the name of the program, school, period, program start date, program end date, description, active, eligibility (depending on grade, age and gender), program locations, and capacity, is illustrative and may be stored in the database and associated with programs and service providers for use by the system. FIG. 23 depicts an illustrative view 2300 of indicators and sub indicators and related data according to an embodiment of the invention. The indicators and/or sub indicators may be identified to the system and configured to be used in a school district or for a group of students. The identified indicators may also be associated with surveys and scoring as described above.

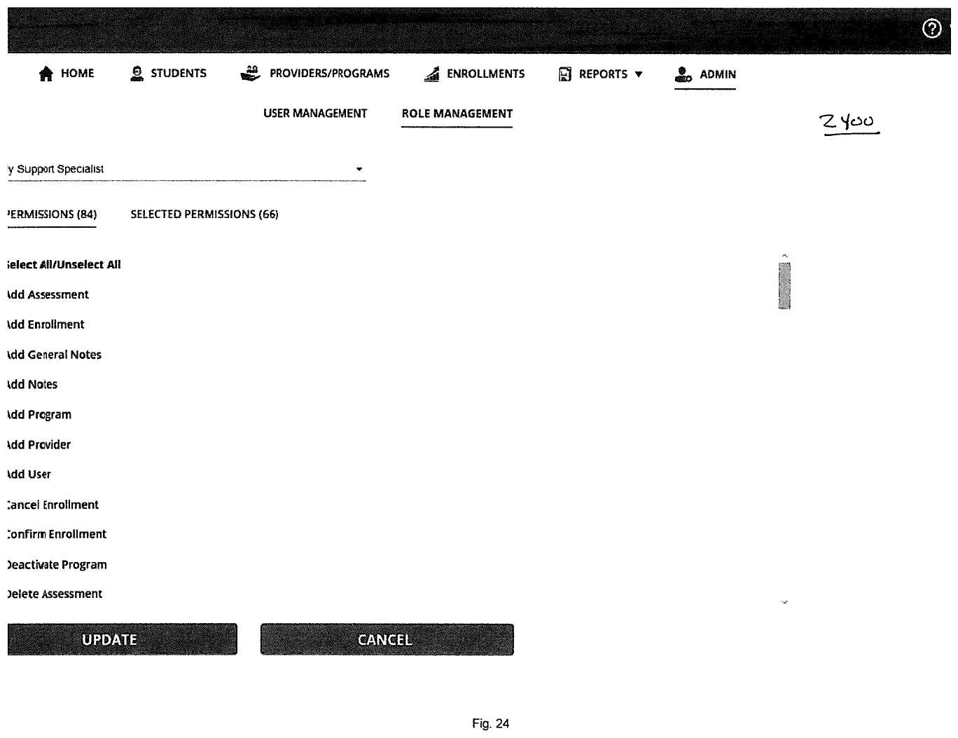

FIG. 24 depicts an illustrative view 2400 of a user interface for a system administrator to provision users according to an embodiment of the present invention. The administrator may set up a user to have very limited access to the system.

Alternatively, a user may be set up to have comprehensive access to data associated with each student and the school or school district. Anything in between limited access and full access is contemplated and may be setup as illustratively shown. The administrator may, as shown, use interactive links provided through the user interface 2400 to manage users and roles of users, and to select and associate permissions with users, such as case managers.

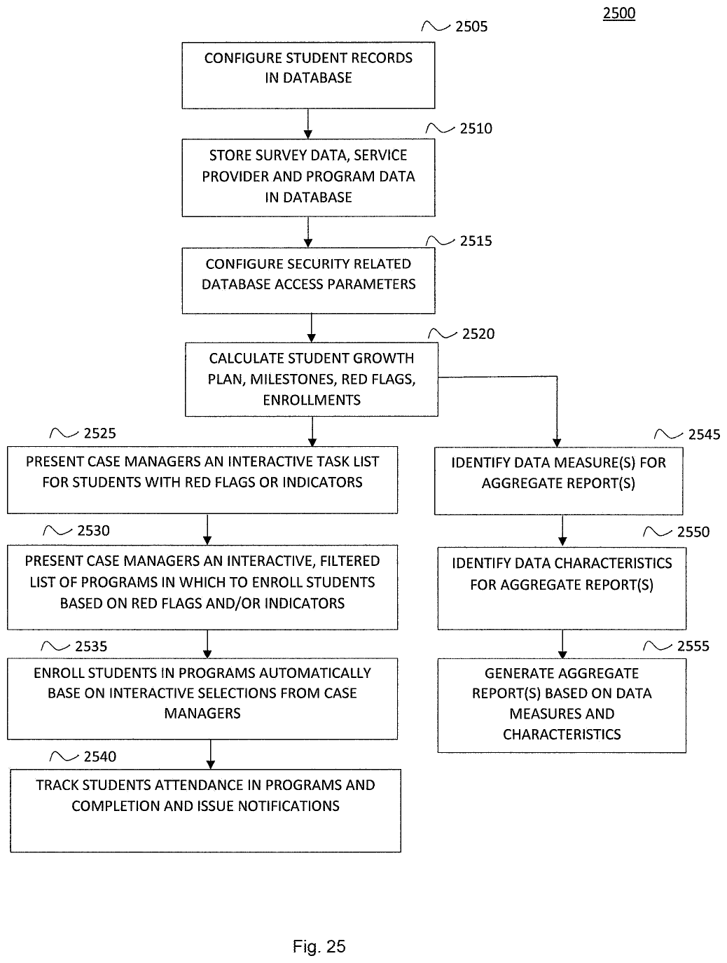

FIG. 25 depicts an illustrative method 2500 according to an embodiment of the invention. Referring to FIG. 25, in step 2505 an interactive system or its administrator configures database records for access. Generally these are student records within a state, school district or school. In step 2510, additional data is stored in the database, including for example survey data, service provider data and data on programs for students. In steps 2515, an administrator configures security related database and system access parameters so that case managers and other administrators can access certain parts of the system and its functionality but not others. In step 2520, the system calculates student growth plan, milestones, red flags, enrollments and other information. This calculation may be done continuously, daily, weekly, monthly or at other regular or irregular intervals or the calculations in aggregate or per student may be event driven. In step 2525, case managers are presented with an interactive task list for students including red flags and indicators. Each case manager may be configured to be given interactive access to a subset of students within the system. In step 2530, case managers are presented an interactive list of programs in which to enroll students based on red flags and/or indicators. The enrollments may be made on other bases as well. The list of programs may be filtered so that only programs that are available to each student are presented for that student. In steps 2535, students are automatically enrolled in a program after it is selected for a student by an administrator. In step 2540, students attendance in programs is tracked, along with completion and any notes from service providers. Notifications of attendance and completion may be communicated in messages to case managers and administrators. Other system messages may also be communicated to case managers and administrators. In step 2545, data measure for aggregate reports may be set up. For example, the data measures may include red flags, indicators, pathway milestones, and survey responses. In step 2550, data characteristics for aggregate reports may be set up, such as demographics, geography and school, among others. In step 2555, the system generates the aggregate reports based on the data measures and characteristics set up for each aggregate report. The reports may be sent to case managers, administrators, or other system users.

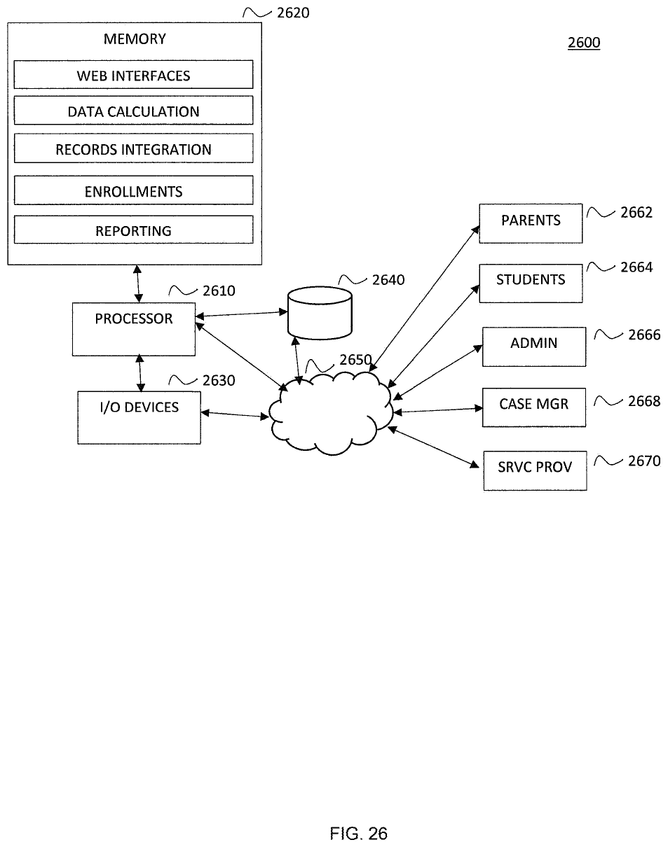

FIG. 26 depicts an embodiment of the invention which illustrates the system and its interaction with various users over a network. Referring to FIG. 26, the system may include a processor 2610 in communication with a memory 2620, I/O devices 2630, a network or cloud 2650, a database 2640, and various users including parents 2662, students 2664, administrators 2666, case managers 2668 and service providers 2670. The memory 2620 includes various programs including web interfaces, data calculation, records integration, enrollments and reporting. Each program includes program instructions executed by the processor. All of the programs and functionality described herein may be stored in the memory as programs with corresponding program instructions. The I/O devices include keyboards, modems, displays, mice, printers and other peripherals. Modems are used to connect the processor via the network 2650 to the various users. The database 2640 may include multiple databases and may be accessed directly by the processor 2610 or indirectly via the network 2650.

While particular features and advantages of the present invention have been shown and described herein, it will be understood by those having ordinary skill in the art that changes may be made to those embodiments without departing from the spirit and scope of the invention.

What is claimed is:

1. A cross-functional information system that facilitates constructive student intervention, comprising:
a memory storing computer programs instructions that facilitate database access and providing data for a user interface that highlights indicators and red flags for students to a user;
a database that stores for each student at least indicators, red flags and enrollments;
a processor, coupled to the memory and the database, that executes the computer program instructions in order to: (a) present information to a user via a user interface in the form of a task list for students that have at least one of an indicator or a red flag that signify that a student needs help; (b) present information to the user on available programs associated with each indicator or red flag associated with each student; (c) present the user information on service providers that are available to provide the available program; and (d) enroll the student in the available program with the available service provider.

2. The system according to claim 1, wherein the processor is further configured to execute the computer program instructions in order to:
(f) enroll a student in the available program;
(g) track program attendance and provide attendance data to the case manager; and
(h) electronically notify the case managers, service providers and optionally the student and the student's parents of results based on the services.

3. The system according to claim 2, wherein the electronic notification in (h) comprises notification of completion of the services.

4. The system according to claim 2, wherein the notification in (h) comprises providing notes regarding the services.

5. The system according to claim 1, wherein the processor is further configured to execute the computer program instructions to:
develop student growth plans for each student based on the school district records for each student, the online survey data, statewide data and the service provider data; and
present an interactive growth plan for each student to the case managers.

6. The system according to claim 5, wherein the processor is further configured to execute the computer program instructions:
develop pathway milestones for each student based on the school district records for each student, the online survey data, statewide data, and the service provider data; and
present the pathway milestones for each student to the case manager.

7. The system according to claim 1, wherein the processor is further configured to execute the computer program instructions to:
incorporate data from online surveys associated with physical health, mental health, medical care, dental care, home environment, postsecondary aspirations, and special care.

8. The system according to claim 1, wherein the processor is further configured to execute the computer program instructions to:
creating aggregate reports on student well-being.

9. The system according to claim 8, wherein the aggregate reports are aggregated according to at least one data measure.

10. The system according to claim 9, wherein the data measure includes at least one of: red flags, indicators, pathway milestones, survey responses.

11. The system according to claim 10, wherein the aggregate reports are filtered according to at least one of the following data characteristic demographic, geography, and school.

12. The system according to claim 1, wherein each system user's access to application data and functions is selectively controlled according to privacy criteria based on at least one of role, school and provider company association.

13. A method that facilitates constructive student intervention, comprising:
configuring a management system to have access to a student record database;
providing the student record database with records associated with student school district records, on-line survey data, service provider data;
configuring security related access parameters for administrators and third parties to portions of the database;
calculating for each student a growth plan, red flags and enrollments based on the school district records for each student, the online survey data, statewide data and the service provider data;
providing a user interface to case managers and third party service providers to:
(a) present an interactive task list for students that have at least one of an indicator or a red flag that signify that a student needs help;
(b) present an interactive list of available programs associated with each indicator or red flag associated with each student, filtered to exclude programs that the student is not eligible to participate in;
(c) present an interactive list of service providers that are available to provide the available program to each student in need; and
(d) enroll a student in the available program with the available service provider.

14. The method according to claim 13, further comprising:
providing an interactive user interface to third party service providers to enable communication and updating of the database to:
(f) enroll a student in the available program;
(g) track program attendance and provide attendance data to the case manager;
(h) electronically notify the case managers, service providers and optionally the student and the student's parents of results based on the services.

15. The method according to claim 14, wherein the electronic notification in step (h) comprises notification of completion of the services.

16. The method according to claim 14, wherein the notification in step (h) comprises providing notes regarding the services.

17. The method according to claim 13, further comprising:
developing student growth plans for each student based on the school district records for each student, the online survey data, statewide data and the service provider data; and
presenting an interactive growth plan for each student to the case managers.

18. The method according to claim 16, further comprising:
developing pathway milestones for each student based on the school district records for each student, the online survey data, statewide data, and the service provider data; and
presenting the pathway milestones for each student to the case manager.

19. The method according to claim 13, further comprising:
online surveys containing data associated with physical health, mental health, medical care, dental care, home environment, postsecondary aspirations, and special care.

20. The method according to claim 13, further comprising:
creating aggregate reports on student well-being.

21. The method according to claim 20, wherein the aggregate reports are aggregated according to at least one data measure.

22. The method according to claim 21, wherein the data measure includes at least one of: red flags, indicators, pathway milestones, survey responses.

23. The method according to claim 21, wherein the aggregate reports are filtered according to at least one of the following data characteristic demographic, geography, and school.

24. The method according to claim 13, wherein each system user's access to application data and functions is selectively controlled according to privacy criteria based on at least one of role, school and provider company association.
